(19) United States
(12) Patent Application Publication
(10) Pub. No.: US 2022/0347675 A1
(43) Pub. Date: Nov. 3, 2022

(54) DEVICE WITH MICROFLUIDIC CHANNELS

(71) Applicant: Hewlett-Packard Development Company, L.P., Spring, TX (US)

(72) Inventor: Alexander N. Govyadinov, Corvallis, OR (US)

(73) Assignee: Hewlett-Packard Development Company, L.P., Spring, TX (US)

(21) Appl. No.: 17/417,808

(22) PCT Filed: Jul. 24, 2019
(86) PCT No.: PCT/US2019/043290

§ 371 Date: Jun. 24, 2021

(51) Int. Cl. B01L 3/00; B01F 33/30; B01F 25/54

(52) U.S. Cl. CPC B01L 3/50273; B01F 33/30; B01F 25/54; B01F 2035/99

(57) ABSTRACT

An example device with a microfluidic channel for use in a chamber is provided, the example device comprising: a chamber to contain a fluid; a microfluidic channel located internal to the chamber, the microfluidic channel having an entrance within the chamber and an exit within the chamber, the microfluidic channel defined by a housing located within the chamber; a unidirectional displacement mechanism inside the microfluidic channel, the unidirectional displacement mechanism located between the entrance and the exit; and a controller to activate the unidirectional displacement mechanism to cause the fluid from the chamber to enter the microfluidic channel via the entrance and leave the microfluidic channel via the exit thereby agitating the fluid within the chamber, the fluid otherwise being non-moving.

### BACKGROUND

Microfluidic devices generally suffer from a lack of natural convection, for heat and/or reagents, which can be problematic when polymerase chain reaction (PCR) microreactors are small enough to be microfluidic devices and/or microvolumes, and when the PCR reactors rely on convective flows. Such microfluidic devices may rely only on heat diffusion during thermo-conductive heating/cooling and diffusion of reagents during bio-chemical reaction. Such reliance slows down heating/cooling cycle speed and may limit speed of chemical reactions due to depletion of reagent concentration in a reaction zone.

### BRIEF DESCRIPTION OF THE DRAWINGS

Reference will now be made, by way of example only, to the accompanying drawings in which:

FIG. 1 is a block diagram of an example device with a microfluidic channel for use in a chamber.

FIG. 2 is a block diagram of another example device with a microfluidic channel for use in a chamber.

FIG. 3 is a top view of the device of FIG. 2.

FIG. 4 is a block diagram of another example device with a microfluidic channel for use in a chamber that includes a plurality of channels in a same direction.

FIG. 5 is a block diagram of another example device with a microfluidic channel for use in a chamber that includes a plurality of channels pumping fluid in opposite directions.

FIG. 6 is a block diagram of another example device with a microfluidic channel for use in a chamber that includes a plurality of U-shaped channels with entrances and exits on a same side of a housing.

FIG. 7 is a block diagram of another device with a microfluidic channel for use in a chamber that includes a plurality of U-shaped channels with entrances and exits on opposite sides of a housing.

FIG. 8 is a block diagram of another example device with a microfluidic channel for use in a chamber that includes a plurality of straight and U-shaped channels.

FIG. 9 is a block diagram of another example device with a microfluidic channel for use in a chamber that includes a plurality of straight and M-shaped channels.

FIG. 10 is a top view of a block diagram of another example device with a microfluidic channel for use in a chamber that includes a two channels formed in different housings.

FIG. 11 is a block diagram of another example device with a microfluidic channel for use in a chamber that includes a channel with an entrance in a top of a housing and an exit in a side of a housing.

FIG. 12 is a block diagram of another example device with a microfluidic channel for use in a chamber that includes a channel with two entrances in a top and side of a housing and an exit in a side of a housing.

FIG. 13, FIG. 14, FIG. 15, FIG. 16 and FIG. 17 depict top views of respective device with a microfluidic channel with different top entrance configurations.

FIG. 18 is a block diagram of another example device with a microfluidic channel for use in a chamber that includes an entrance and exit to a channel that are flush with a floor of a chamber.

FIG. 19 is a block diagram of another example device with a microfluidic channel for use in a chamber that includes an entrance and exit to a channel that are flush with a floor of a chamber using an overmold configuration.

FIG. 20 is a block diagram of another device with a microfluidic channel for use in a chamber that includes an entrance and exit to a channel that are flush with a floor of a chamber using a fluid molded interconnect device and walls of a chamber that are flush with walls of a housing.

FIG. 21 is a block diagram of a method for use with a device with a microfluidic channel for use in a chamber.

### DETAILED DESCRIPTION

Microfluidic devices generally suffer from a lack of natural convection, for heat and/or reagents, which can be problematic when, for example, polymerase chain reaction (PCR) microreactors are small enough to be microfluidic devices and/or microvolumes, and when the PCR reactors rely on convective flows. Such microfluidic devices may rely only on heat diffusion during thermo-conductive heating/cooling and diffusion of reagents during bio-chemical reaction. Such reliance slows down heating/cooling cycle speed and may limit speed of chemical reactions due to depletion of reagent concentration in a reaction zone. Hence, microfluidic devices provided herein use active mixing, and in particular, micromixing to address these situations. Micromixing may significantly accelerate heat/cool time, due to faster heat exchange, and increase reaction efficiency due to increased mass transfer and enforced diffusion, as compared to microfluidic devices that rely on diffusion only.

An aspect of the present specification provides a device comprising: a chamber to contain a fluid; a microfluidic channel located internal to the chamber, the microfluidic channel having an entrance within the chamber and an exit within the chamber, the microfluidic channel defined by a housing located within the chamber; a unidirectional displacement mechanism inside the microfluidic channel, the unidirectional displacement mechanism located between the entrance and the exit; and a controller to activate the unidirectional displacement mechanism to cause the fluid from the chamber to enter the microfluidic channel via the entrance and leave the microfluidic channel via the exit thereby agitating the fluid within the chamber, the fluid otherwise being non-moving.

The housing may have a top hat configuration extending into the chamber.

The controller may comprise a complementary metal-oxide-semiconductor (CMOS) controller.

The entrance and the exit of the microfluidic channel may be located on opposing sides of the housing.

One of the entrance and the exit of the microfluidic channel may be located on a top side of the housing and the other of the entrance and the exit of the microfluidic channel is located on a side of the housing perpendicular to the top side.

The unidirectional displacement mechanism may comprise a thermal inkjet resistor.

The device may further comprise: a second microfluidic channel having a second entrance within the chamber and a second exit within the chamber; a second unidirectional displacement mechanism inside the second microfluidic channel, the second unidirectional displacement mechanism located between the second entrance and the second exit; and the controller may be to activate the second unidirectional displacement mechanism to cause the fluid from the chamber to enter the second microfluidic channel via the second entrance and leave the microfluidic channel via the second exit.

Another aspect of the present specification provides a method comprising: containing fluid in a chamber, wherein a microfluidic channel is located internal to the chamber, the microfluidic channel having an entrance within the chamber and an exit within the chamber; activating a unidirectional displacement mechanism inside the microfluidic channel, the unidirectional displacement mechanism located between the entrance and the exit, to cause the fluid from the chamber to enter the microfluidic channel via the entrance and leave the microfluidic channel via the exit thereby agitating the fluid within the chamber, the fluid otherwise being non-moving.

The method may further comprise: activating the unidirectional displacement mechanism to cause the fluid from the chamber to enter the microfluidic channel via the entrance and leave the microfluidic channel via the exit and a second exit.

A second microfluidic channel may be located internal to the chamber, the second microfluidic channel having a second entrance within the chamber and a second exit within the chamber, and the method may further comprise: activating a second unidirectional displacement mechanism inside the second microfluidic channel, the second unidirectional displacement mechanism located between the second entrance and the second exit, to cause the fluid from the chamber to enter the second microfluidic channel via the second entrance and leave the microfluidic channel via the second exit.

The method may further comprise: providing the entrance and the exit are above a floor of the chamber.

The method may further comprise: providing the entrance and the exit flush with a floor of the chamber.

The unidirectional displacement mechanism may comprises a thermal inkjet resistor inkjet device, and activating unidirectional displacement mechanism comprises activating the thermal inkjet resistor inkjet device.

The method may further comprise: providing the microfluidic channel as straight, U-shaped or a combination thereof. Another aspect of the present specification provides a device comprising: a chamber to contain a fluid; a microfluidic channel located internal to the chamber, the microfluidic channel having an entrance within the chamber and an exit within the chamber, the microfluidic channel defined by a housing located within the chamber, the microfluidic channel being straight; a thermal inkjet resistor inside the microfluidic channel, the thermal inkjet resistor located between the entrance and the exit; and a controller to activate the thermal inkjet resistor to cause the fluid from the chamber to enter the microfluidic channel via the entrance and leave the microfluidic channel via the exit thereby agitating the fluid within the chamber.

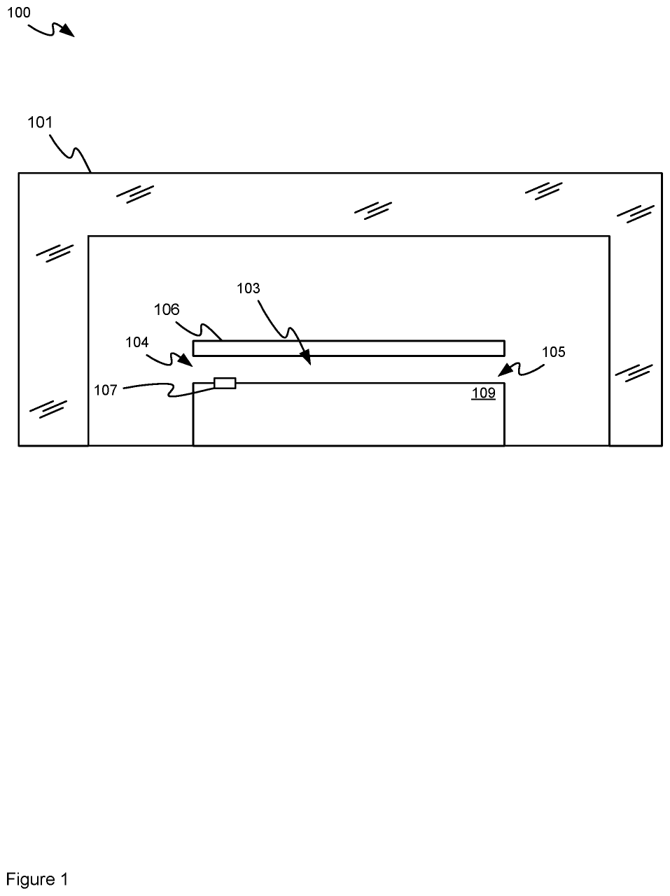

Referring to FIG. 1, a device 100 with a microfluidic channel for use in a chamber is schematically depicted, including, but not limited to, a PCR microreactor, an isothermal microreactor, and the like. The device 100 comprises: a chamber 101 to contain a fluid (not depicted in FIG. 1); a microfluidic channel 103 located internal to the chamber 101, the microfluidic channel 103 having an entrance 104 within the chamber 101 and an exit 105 within the chamber 101, the microfluidic channel 103 defined by a housing 106 located within the chamber 101; a unidirectional displacement mechanism 107 inside the microfluidic channel 103, the unidirectional displacement mechanism 107 located between the entrance 104 and the exit 105; and a controller 109 to activate the unidirectional displacement mechanism 107 to cause fluid from the chamber 101 to enter the microfluidic channel 103 via the entrance 104 and leave the microfluidic channel 103 via the exit 105 thereby agitating the fluid within the chamber 101, the fluid otherwise being non-moving.

While not depicted in FIG. 1, the device 100 may generally reside on a substrate (e.g. such as a silicon substrate), and the chamber 101, such as a PCR chamber may be placed on the device 100 and filled with fluid, such that the device 100 micromixers the fluid in the chamber 101. Alternatively, the chamber 101 may comprise a capillary tube and the device 100 may be inserted into the capillary tube to mix fluids therein. Hence, in some examples, the microfluidic channel 103, the entrance 104, the exit 105, the housing 106, the unidirectional displacement mechanism 107 and the controller 109 may be provided without the chamber 101, for example for insertion into the chamber 101

In general, a chamber as described herein refers to a chamber where fluid may be located, with the fluid in the chamber being generally still (e.g. not moving) other than as mixed by the device 100. Hence, for example, a chamber as described herein does not generally contain flowing liquid and/or is not in fluidic communication with an external pump and the like. Rather, a chamber as described herein is generally fluidically isolated such that chemicals within the a fluid therein may react in an isolated manner, including, but not limited to, in a PCR. In some examples, the chamber 101 comprises a microfluidic reaction chamber. A microfluidic reaction chamber refers to a chamber where a chemical reaction, or any other manipulation, processing, or sensing operation occurs.

Furthermore, a plurality of the devices 100 may reside on the substrate, and a plurality of chambers placed on the plurality of devices 100 to micromix a plurality of fluids in the plurality of chambers. In some examples, hundreds to thousands and/or any suitable number of the devices 100 may be fabricated on a substrate and/or a silicon substrate and used with hundreds to thousands and/or any suitable number of complementary chambers, for example to micromix hundreds to thousands and/or any suitable number of fluids containing different and/or the same PCR samples.

As depicted the microfluidic channel 103, interchangeably referred to hereafter as the channel 103, is straight (e.g. lengthwise), however the channel 103 may be any suitable lengthwise shape, including, but not limited to, U-shaped, M-shaped, W-shaped and the like, and/or any suitable combination thereof. In some examples, the lengthwise shape of the channel 103 may depend on a shape of the chamber within which the device 100 is to reside and/or a reaction volume of the chamber. The channel 103 may be of any suitable cross-sectional shape including, but not limited to, square, rectangular, round and/or oval, a figure-8 shape, with the entrance 104 and the exit 105 having similar cross-sectional shapes. In general, the channel 103 may be formed using any suitable material, including, but not limited to, photoresist, SU8 photoresist, Polydimethylsiloxane (PDMS) and the like. In some examples, the channel 103 may be formed using patterned channel layer in a photoresist and enclosed by top hat layer made of photoresist and/or solid plate, such a top hat layer may comprise a 4-30 μm laminated plastic layer, and/or solid glass, plastic and/or metal plate up to a few hundred microns thick

Furthermore, while the entrance 104 and the exit 105 are depicted on opposite sides of the device 100, the entrance 104 and the exit 105 may be in any suitable location. For example, one of the entrance 104 and the exit 105 may be at a side of the device 100 and the other of the entrance 104 and the exit 105 may be at a top of the device 100 (e.g. where “top” refers to the orientation depicted in FIG. 1, though the device 100 may be in any suitable orientation).

While only one channel 103 is depicted, the device 100 may comprise more than one channel 103, each including a respective unidirectional displacement mechanism, which may be controlled by the controller 109 and/or a respective controller, for example to micromix fluids in the chamber using a plurality of channels.

For example, the device 100 may further comprise: a second microfluidic channel having a second entrance within the chamber and a second exit within the chamber; a second unidirectional displacement mechanism inside the second microfluidic channel, the second unidirectional displacement mechanism located between the second entrance and the second exit; and the controller to activate the second unidirectional displacement mechanism to cause the fluid from the chamber to enter the second microfluidic channel via the second entrance and leave the microfluidic channel via the second exit. In some of these examples, the microfluidic channel 103 is straight (e.g. as depicted) and the second microfluidic channel is U-shaped. However, in other examples, the microfluidic channel 103 is straight (e.g. as depicted) and the second microfluidic channel is also straight. Furthermore, in some of these examples, the fluid is controlled to move through the channel 103 and the second microfluidic channel in a same direction while, in other examples, the fluid is controlled to move through the channel 103 and the second microfluidic channel in different directions, as will be described below.

The unidirectional displacement mechanism 107 may comprises an inkjet device, such as a thermal inkjet device and/or a thermal inkjet resistor and/or a piezoelectric inkjet device. However, the unidirectional displacement mechanism 107 may be any suitable displacement mechanism including, but not limited to, a mechanical impact device, a pneumatic actuated membrane, a magnetostricter, an electro-mechanical membrane, an alternating current (AC) electro-osmotic actuator, and the like.

The controller 109 may comprise a complementary metal-oxide-semiconductor (CMOS) controller, for example integrated onto a silicon substrate. However, the controller 109 may comprise any suitable type of controller for controlling the unidirectional displacement mechanism 107. In these examples, the controller 109 may be connected to an external computing device and/or power supply, which controls the controller 109 to turn on and off so that the controller 109 may control the unidirectional displacement mechanism 107. While the controller 109 is depicted as a certain relative size to the channel 103, the controller 109 may be fabricated onto silicon, such as a silicon pedestal extending from a silicon substrate, and occupy only a portion of the pedestal, for example adjacent the channel 103; hence, the relative sizes of components of devices depicted throughout the present specification are understood to be schematic only and not actual relative sizes.

The controller 109 may alternatively be located external to the portion of the device 100 that resides in the chamber and in electronic communication with the unidirectional displacement mechanism 107 via suitable connections via the substrate.

Other alternatives for the device 100 are within the scope of the present specification and described hereafter.

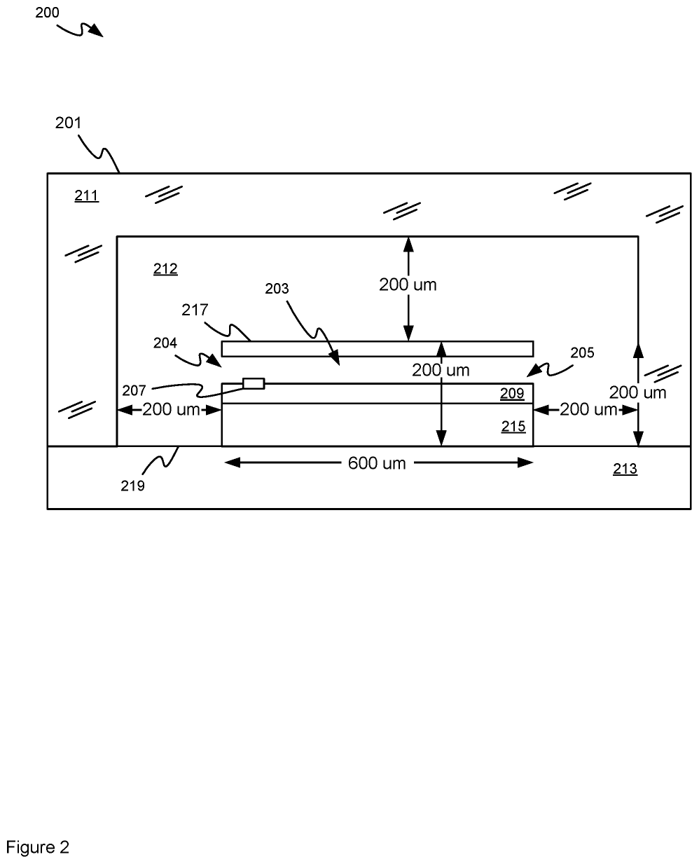

Attention is next directed to FIG. 2 which depicts a device 200 (interchangeably referred to hereafter as the device 200) for a microreactor is schematically depicted. The device 200 is similar to the device 100, with like components having like numbers but in a “200” series rather than a “100” series. The device 200 comprises: a chamber 201 to contain a fluid; a microfluidic channel 203 having an entrance 204 within the chamber 201 and an exit 205 within the chamber 201; a unidirectional displacement mechanism 207 inside the microfluidic channel 203, the unidirectional displacement mechanism 207 located between the entrance 204 and the exit 205; and a controller 209 to activate the unidirectional displacement mechanism 207 to cause fluid from the chamber 201 to enter the microfluidic channel 203 via the entrance 204 and leave the microfluidic channel 203 via the exit 205 thereby agitating the fluid within the chamber 201. Hence, the device 200 is similar to the device 100.

As depicted, the chamber 201 comprises a lid 211 comprising glass, plastic and/or any other suitable material, that defines a space 212 of the chamber 201 within which at least the entrance 204 and exit 205 of the microfluidic channel 203 (interchangeably referred to hereafter as the channel 203) are located. Fluid may be introduced into the chamber 201 (e.g. into the space 212), and the controller 209 may control the unidirectional displacement mechanism 207 to micromix the fluid in the chamber 201.

As depicted, the device 200 includes a substrate 213, for example silicon and the like, which includes a pedestal 215 extending into the chamber 201, with the controller 209 (e.g. a CMOS device) formed on the pedestal 215 using any suitable fabrication techniques. An external connection to the controller 209 is not depicted but is understood to be present.

The channel 203 may be formed on the controller 209 using, for example, any suitable material, including, not limited to, photoresist, SU8 photoresist, and the like, formed, for example, in a top-hat configuration. In the depicted example, the device 200 further comprises a housing 217, through which the channel 203 extends; as described above, the housing 217 may comprise any suitable combination of photoresist and/or top-hat layers. Put another way, the microfluidic channel 203 is defined by the housing 217 located within the chamber 201. For example, while back and front walls of the channel 203 are not depicted in FIG. 2 (or FIG. 1), the channel 203 is generally through the housing 217 and includes front and back walls, as well as top and bottom walls, and hence the channel 203 may be rectangular and/or square in cross-section. however, the channel 203 may be of any suitable cross-sectional shape as described above.

As depicted, the entrance 204 and the exit 205 are located on opposing sides of the housing 217. However, in other examples, one of the entrance 204 and the exit 205 of the microfluidic channel 203 may be located on a top side of the housing 217 and the other of the entrance and the exit of the entrance 204 and the exit 205 of the microfluidic channel 203 may be located on a side of the housing 217 perpendicular to the top side (e.g. where “top” refers to the orientation depicted in FIG. 2, though the device 200 may be in any suitable orientation).

As depicted, the entrance 204 and the exit 205 are located above a floor 219 of the chamber 201 (e.g. a surface of the chamber 201 from which the pedestal 215 extends). However, in other examples, the entrance 204 and the exit 205 may be flush with the floor 219 of the chamber 201; for example, the pedestal 215 may not be present in the device 200 and the controller 209 may be at least partially contained in the floor 219 using, for example, overmold material, as described below.

In yet further examples, the microfluidic channel 203 may include a second exit, and the controller 209 may be to activate the unidirectional displacement mechanism 207 to cause the fluid from the chamber 201 to enter the microfluidic channel 203 via the entrance 204 and leave the microfluidic channel 203 via the exit 205 and the second exit. Similarly, in yet further examples, the microfluidic channel 203 may include a second entrance, and the controller 209 may be to activate the unidirectional displacement mechanism 207 to cause the fluid from the chamber 201 to enter the microfluidic channel 203 via the entrance 204 and second entrance and leave the microfluidic channel 203 via the exit 205.

FIG. 2 also shows dimensions of the example device 200. As depicted, the channel 203 is about 600 μm long between the entrance 204 and the exit 205, the top of the housing 217 is about 200 μm above a floor 219 of the chamber 201, and there is about 200 μm between each of the entrance 204, the exit 205, the top of the housing 217, and a respective closest interior wall of the chamber 201. However, the device 200 may be of any suitable dimensions compatible, for example, with PCR reactions. For example, in other examples, the channel 203 may be about 200 μm long between the entrance 204 and the exit 205, and dimensions of the chamber 201 adjusted accordingly (e.g. to maintain about 200 μm between interior wall of the chamber 201 and the remainder of the device 200.

In some examples, the housing 217 maybe be between in a range of about 1 μm to a few hundred μm in thickness, with the other dimensions of the device 200 adjusted accordingly. The channel 203 may be between about 5×5 um to about 100×200 um in cross-section, with the other dimensions of the device 200 adjusted accordingly. While not depicted, a depth of the device 200 (e.g. “into and/or out the page” of FIG. 2 may be in a range of between about 100 μm to about 75 mm

While as depicted there is about 200 μm between each of the entrance 204, the exit 205, the top of the housing 217, and a respective closest wall of the chamber 201, there may be between 10 μm to about 2000 μm wider between the entrance 204, the exit 205, and/or the top of the housing 217 (e.g. a top of a top hat layer, a top layer, a channel cover, and the like), and a respective closest wall of the chamber 201, with the other dimensions of the device 200 adjusted accordingly.

A size of the unidirectional displacement mechanism 207 may be dependent on a size of the channel 203. When the unidirectional displacement mechanism 207 comprises a thermal inkjet device, and in particular a thermal inkjet resistor, a size of the thermal inkjet resistor may be between about 6×20 μm² to about 200×300 μm². In these examples, a maximum area of the thermal inkjet resistor may be determined by power to be delivered by the thermal inkjet resistor; in a specific example, the thermal inkjet resistor may be to deliver about 0.1 to about 3 GW/m² in about a 0.4 to 20 μs firing pulse duration However, a firing frequency and/or duration of the thermal inkjet resistor, and/or power delivered thereby, may be of any suitable configuration. The controller 209 may be adapted to control the thermal inkjet resistor accordingly.

A minimum area of a thermal inkjet resistor may be about 100 μm². In another specific example, size of cross-section of the channel 203 may be between about 11×20 μm² to about 32×35 μm², and size of the inkjet resistor may be between about 12×36 μm² to about 25×50 μm².

When the unidirectional displacement mechanism 207 comprises a thermal inkjet device, and in particular a thermal inkjet resistor, the thermal inkjet resistor may also be used as microheater to deliver heat to PCR, and/or any suitable chemical reaction, occurring in fluid in the chamber 201. Operation frequency of the inkjet resistor may vary with heat flux to warm the fluid in the chamber 201, for example the frequency may be increased; similarly, the frequency may be slowed in a cooling down cycle, for example in elongation and annealing parts of a PCR. In particular, operational pulsing during temperature changes of the fluid in the chamber 201 may be adjusted to enable best conditions for steam bubble formation to promote fluid movement through the channel 203 (e.g. precursor pulses and/or total pulse duration can be decreased at elevated temperatures). The controller 209 may be adapted to control the thermal inkjet resistor accordingly.

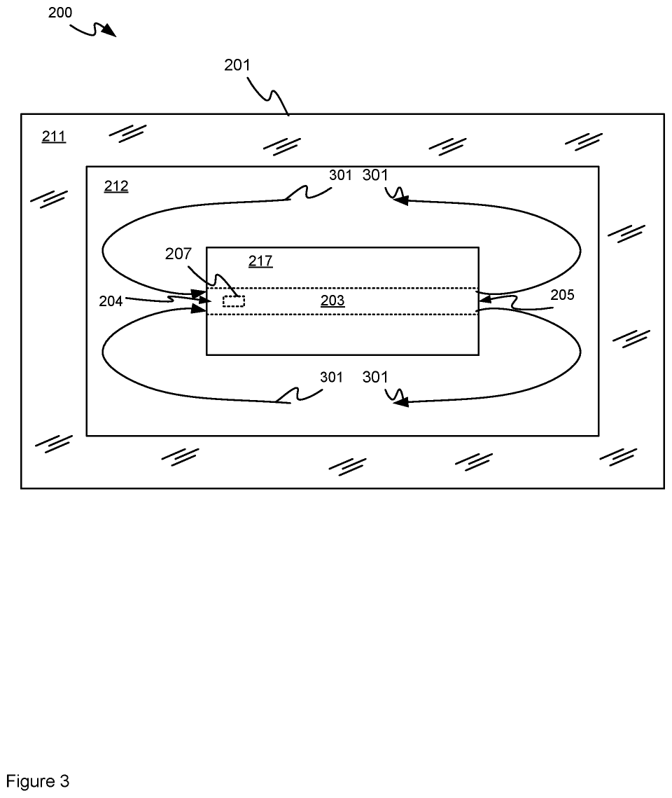

Attention is next directed to FIG. 3 which depicts a top schematic view of the device 200 showing a top of the housing 217, the channel 203 through the housing 217 in dashed lines (e.g. to show the location of the channel 203 within the housing 217), the entrance 204 and the exit 205 of the channel 203, the unidirectional displacement mechanism 207 also depicted in dashed lines (e.g. to show the location of the unidirectional displacement mechanism 207 within the housing 217), and the chamber 201, including the lid 211 and the space 212. In general, the chamber 201 is depicted to show relative positions of the interior walls to the housing 217 (and the entrance 204 and the exit 205), but the chamber 201 generally includes a top portion that encases the remainder of the device 200 therein (e.g. depicted in FIG. 2).

FIG. 3 further depicts a path 301 of fluid within the chamber 201 as the fluid is pumped and/or micropumped into the entrance 204, through the channel 203, and out the exit 205. The path 301 generally shows the micromixing of the fluid within the chamber 201, and further that the fluid may recirculate through the channel 203 (e.g. the fluid leaves the exit 205, moves through the chamber 201, and re-enters the channel 203 via the entrance 204). While not depicted, the path 301 may also be, at least in part, across a top of the housing 417 (e.g. across the top of a top-hat later, a top layer, an channel cover, and the like).

Various alternatives for the devices 100, 200 are next described. In particular, certain alternative device with a microfluidic channel for use in a chamber will be described independent of a chamber, though it is understood that each may be used with a chamber. Microfluidic channels described hereafter will be referred to as channels; similarly, unidirectional displacement mechanism described hereafter will be referred to as mechanisms. Furthermore, channels depicted hereafter in dashed lines indicate a location of a channel within a housing, similar to FIG. 3. Furthermore, while not all components of devices described hereafter are depicted, each is understood to include a respective channel, respective entrances and exits of the respective channels, and respective controllers.

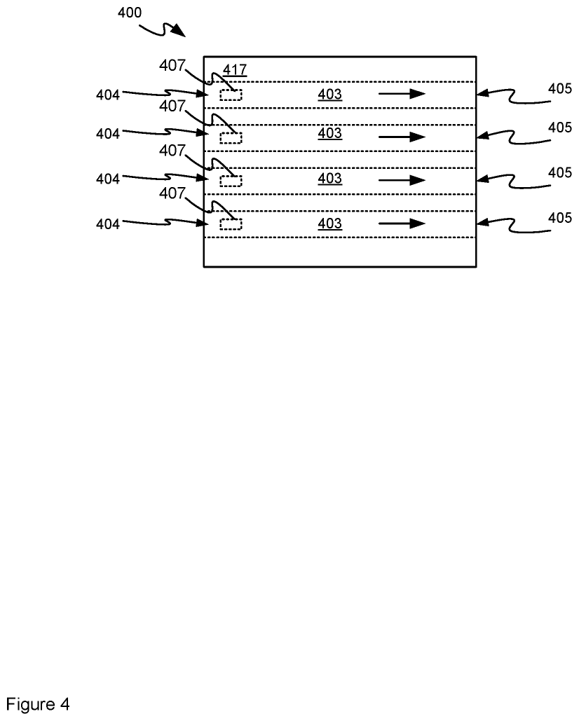

Attention is next directed to FIG. 4 which depicts a top schematic view of a device 400 similar to the devices 100, 200, but including a plurality of channels 403 with respective entrances 404 and exits 405, and respective mechanisms 407, the channels 403 being through a common housing 417. The entrances 404 and exits 405 are at common respective sides of the housing 417, and similarly the mechanisms 407 are to pump fluid through the channels 403 in a same direction, as indicated by the arrows in each of the channels 403. Furthermore, while four channels 403 are depicted, the device 400 may include any suitable number of channels 403. Furthermore, the device 400 generally pumps liquid from one side of the housing 417 to the other side of the housing 417 and/or example across a top of the housing 417.

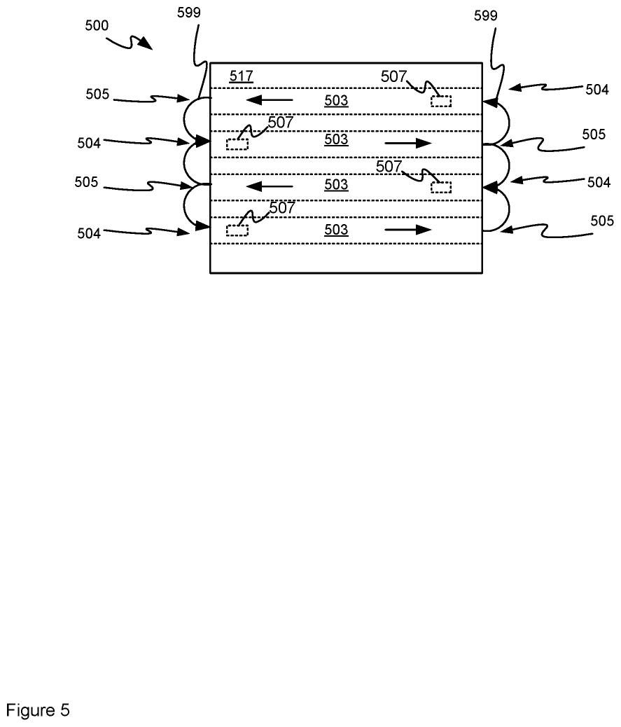

Attention is next directed to FIG. 5 which depicts a top schematic view of a device 500 similar to the device 400, including a plurality of channels 503 with respective entrances 504 and exits 505, and respective mechanisms 507, the channels 503 being through a common housing 517. The entrances 504 and exits 505 are at alternating respective sides of the housing 517, and similarly the mechanisms 507 are to pump fluid through the channels 503 in alternating directions, as indicated by the arrows in each of the channels 503 and by fluid paths 599 showing recirculation of fluid through adjacent channels 503. For example, adjacent channels 503 generally pump fluid in opposing directions. Furthermore, while four channels 503 are depicted, the device 500 may include any suitable number of channels 503. Furthermore, as depicted via the paths 599, liquid pumped from an exit 505 may enter an entrance 504 of an adjacent channel 503 and/or entrances 504 of adjacent channels 503, as well as across a top of the housing 517, which may better agitate the fluid on sides of the housing 517 as compared to the device 400.

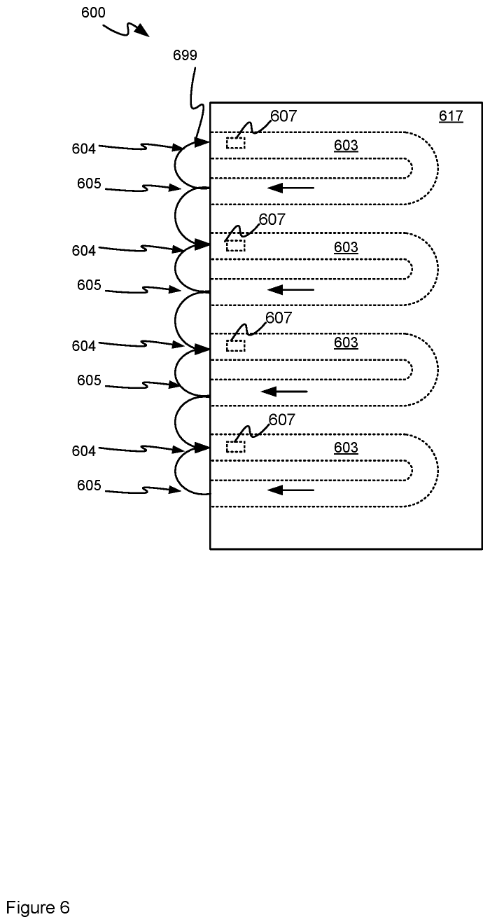

Attention is next directed to FIG. 6 which depicts a top schematic view of a device 600 similar to the device 400, including a plurality of channels 603 with respective entrances 604 and exits 605, and respective mechanisms 607, the channels 603 being through a common housing 617. The channels 603 are U-shaped and hence the entrances 604 and exits 605 for the channels 603 are all on a same of the housing 617, and similarly the mechanisms 607 are to pump fluid through the channels 603 in same direction, as indicated by the arrows in each of the channels 603 and by fluid paths 699 showing recirculation of fluid through adjacent channels 603. Furthermore, while four channels 603 are depicted, the device 600 may include any suitable number of channels 603.

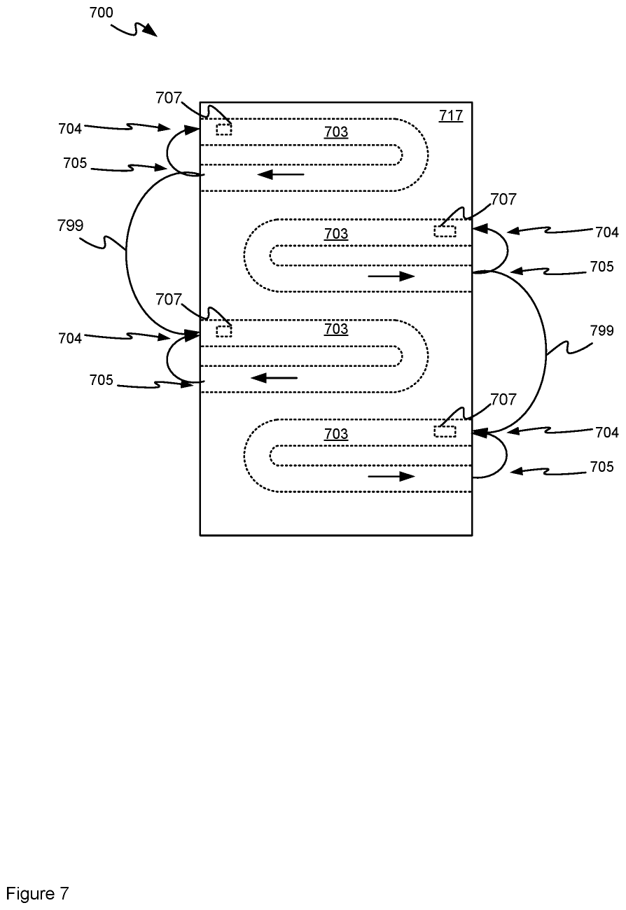

Attention is next directed to FIG. 7 which depicts a top schematic view of a device 700 similar to the device 600, including a plurality of channels 703 with respective entrances 704 and exits 705, and respective mechanisms 707, the channels 703 being through a common housing 717. Like the channels 603, the channels 703 are U-shaped and hence a respective entrance 704 and respective exit 705 for a given channel 703 is on a same of the housing 717. However, respective entrances 704 and respective exits 705 for alternating channels 703 alternate between opposing sides of the housing 717. Furthermore, while four channels 703 are depicted, the device 700 may include any suitable number of channels 703. While the mechanisms 707 are arranged to pump fluid in the directions indicated by the depicted arrows, and by fluid paths 799 showing recirculation of fluid through alternating channels 703 in other examples, the mechanisms 707 in the channels 703, on one of the opposing sides of the housing 717 (e.g. the right-hand side of the housing 717) may be to arranged to pump fluid opposite to the depicted direction such that a position of respective entrances 704 and exits 705 are reversed than as depicted in FIG. 7.

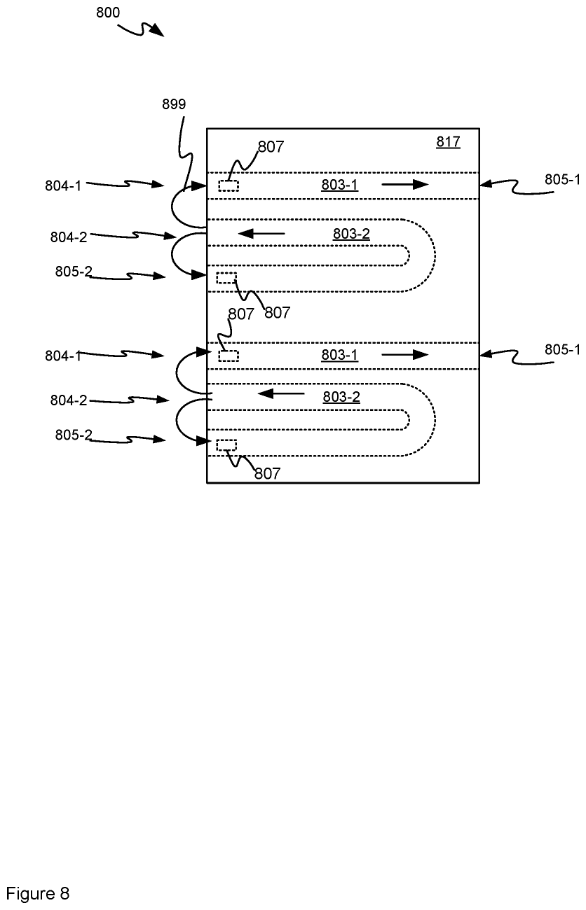

Attention is next directed to FIG. 8 which depicts a top schematic view of a device 800 similar to the device 400, including a plurality of channels 803-1, 803-2 with respective entrances 804-1, 804-2 and exits 805-1, 805-2, and respective mechanisms 807, the channels 803-1, 803-2 being through a common housing 817. Like the channels 403, the channels 803-1 are straight, and like the channels 703, the channels 803-2 are U-shaped. The channels 803-1, 803-2 are provided in pairs, with an entrance 804-2 and exit 805-2 of a U-shaped channel 803-2 being on a same side of the housing 817 as the entrances 804-1 of paired straight channels 803-1; however, in other examples, an entrance 804-2 and exit 805-2 of a U-shaped channel 803-2 may be on a same side of the housing 817 as the exits 805-1 of paired straight channels 803-1. In yet further examples, the arrangement of adjacent paired channels 803-1, 803-2 may alternate, similar to the device 700. In particular movement of fluid through the channels 803-1, 803-2 is indicated by the arrows in each of the channels 803-1, 803-2 and by fluid paths 899 showing recirculation of fluid through adjacent channels 803-1, 803-2, though fluid further flows around the housing 817 from the exits 805-1 to the entrances 804-1, 804-2. As depicted, the fluid is more agitated on a left-hand side of the housing 817 than on a right-hand side.

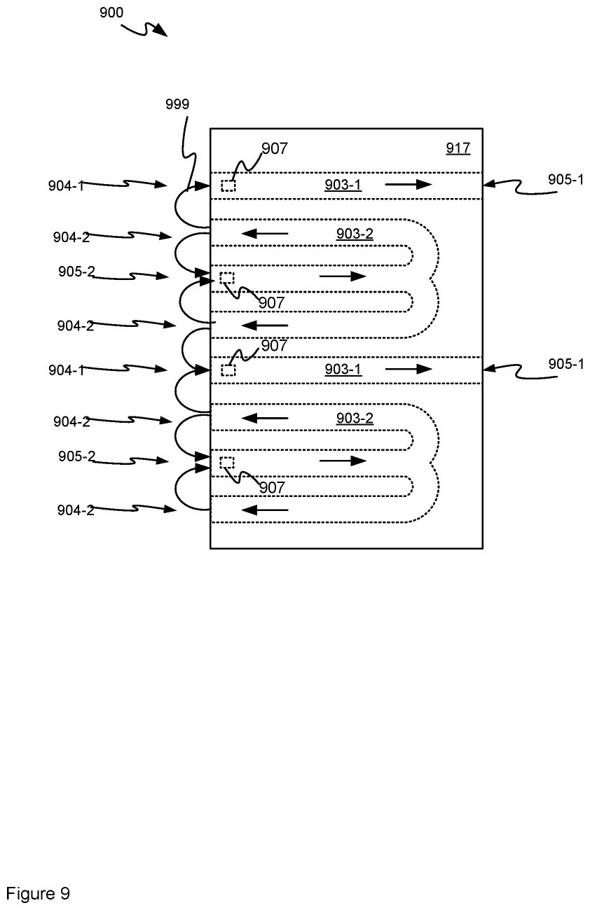

Attention is next directed to FIG. 9 which depicts a top schematic view of a device 900 similar to the device 800, including a plurality of channels 903-1, 903-2 with respective entrances 904-1, 904-2 and exits 905-1, 905-2, and respective mechanisms 907, the channels 903-1, 903-2 being through a common housing 917. Like the channels 403, the channels 903-1 are straight. However, the channels 903-2 are M-shaped and/or W-shaped with respective mechanisms 907 arranged in a central portion of the channels 903-2 such that a channel 903-2 has two entrances 904-2 and one exit 905-2. In other examples, the respective mechanisms 907 of the channels 903-2 may be arranged such that a channel 903-2 has one entrance 904-2 (e.g. at a location of the depicted exits 905-2) and two exits 905-2 (e.g. at a location of the depicted entrances 904-2). The channels 903-1, 903-2 are provided in pairs, with entrances 904-2 and an exit 905-2 of an M-shaped channel 903-2 being on a same side of the housing 917 as the entrances 904-1 of paired straight channels 903-1; however, in other examples, entrances 904-2 and an exit 905-2 of an M-shaped channel 903-2 may be on a same side of the housing 917 as the exits 905-1 of paired straight channels 903-1. In yet further examples, the arrangement of adjacent paired channels 903-1, 903-2 may alternate. In particular movement of fluid through the channels 903-1, 903-2 is indicated by the arrows in each of the channels 903-1, 903-2 and by fluid paths 999 showing recirculation of fluid through adjacent channels 903-1, 903-2, though fluid further flows around the housing 917 from the exits 905-1 to the entrances 904-1, 904-2. As depicted, the fluid is more agitated on a left-hand side of the housing 917 than on a right-hand side.

Heretofore, devices that include more than one channel have been described with the channels through a common housing. However, in other examples, the channels may be fabricated through different housings, for example fabricated on a same pedestals (e.g. silicon pedestals) and/or a different pedestals.

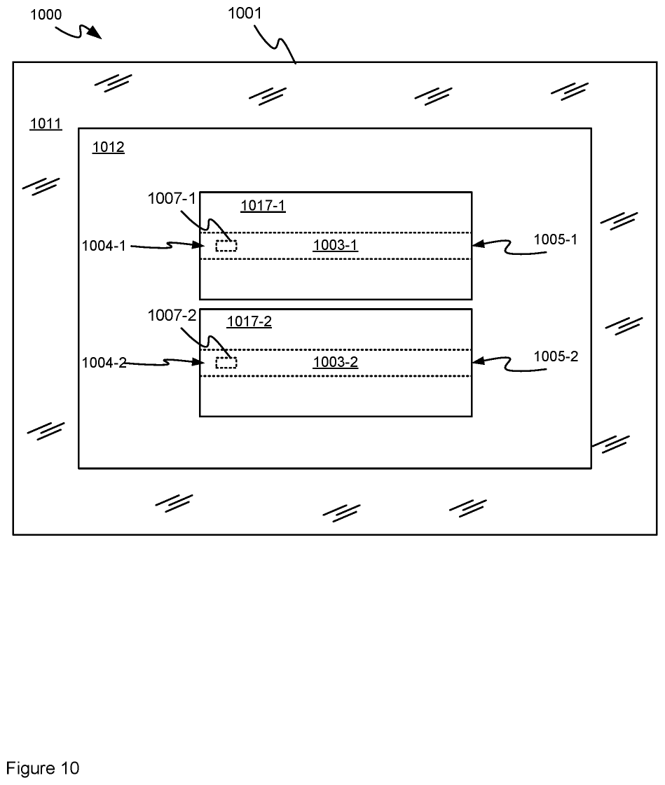

For example, attention is next directed to FIG. 10 which depicts a device 1000 similar to the device 200, depicted in a view similar to that of FIG. 3, with like components having like numbers but in a “1000” series rather than a “200” series. As depicted the device 1000 includes a chamber 1001 and two channels 1003-1, 1003-2 with respective entrances 1004-1, 1004-2, respective exits 1005-1, 1005-2, and respective mechanisms 1007-1, 1007-2 (as well as respective controllers, not depicted). The chamber 1001 generally comprises a lid 1011 and an interior space 1012. Hence, the device 1000 is similar to the device 200 but includes more than one channel 1003-1, 1003-2, similar to the device 400. However, in contrast to the device 400, the channels 1003-1, 1003-2 are through different respective housings 1017-1, 1017-2, which may be fabricated on a common pedestal or different pedestals. Any of the devices 400, 500, 600, 700, 800, 900 may be similarly adapted with adjacent channels being through different housings or a same housing; when the channels are through different housings, in some examples, the different housings may be on different pedestals while in other examples, the different housing may be on the same pedestal.

Furthermore, while the components of the device 1000 are arranged such that respective entrances 1004-1, 1004-2 are adjacent, and similarly respective exits 1005-1, 1005-2 are adjacent, in other examples, the components of the device 1000 may be arranged end-to-end, such that the exit 1005-1 is adjacent and/or arranged in line with the entrance 1004-1. Furthermore, while the device 1000 includes two channels 1003-1, 1003-2, the device 1000 may include more than two channels including, but not limited to four channels arranged end-to-end and/or in any other suitable arrangement.

Heretofore, devices have been described with respect to entrances and exits of channels being on opposing sides of a housing. However, in other examples, an entrance or an exit may be at a top of a housing.

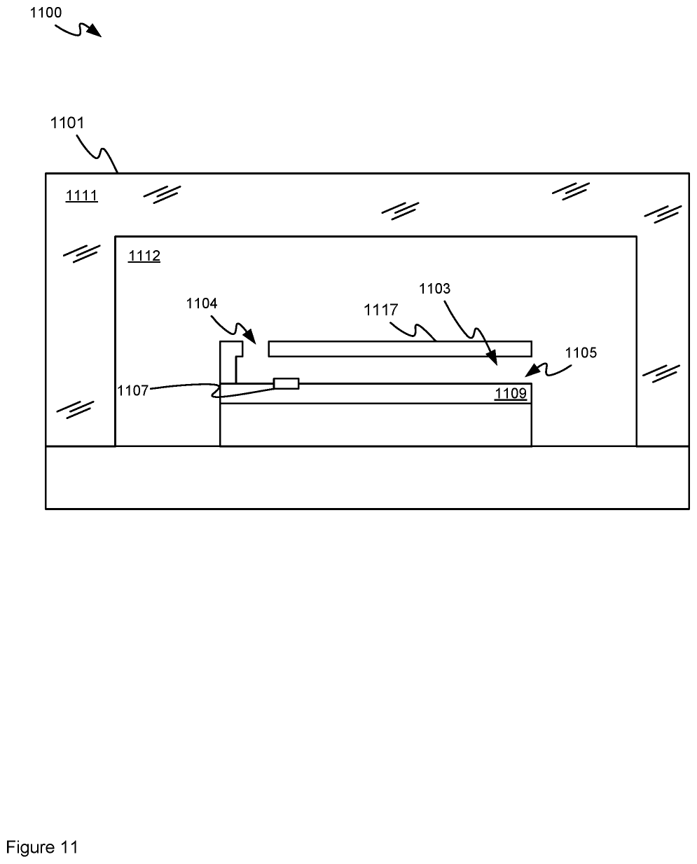

For example, attention is next directed to FIG. 11 which depicts a device 1100 similar to the device 200, depicted in a view similar to that of FIG. 2, with like components having like numbers but in an “1100” series rather than a “200” series. As depicted the device 1100 includes a chamber 1101 and a channel 1103 with an entrance 1104, an exit 1105, a mechanism 1107, and a controller 1109. The chamber 1101 generally comprises a lid 1111 and an interior space 1112. Hence, the device 1100 is similar to the device 200 but the entrance 1104 to the channel 1103 is in top of a housing 1117 and the exit 1105 is on a side of the housing 1117. Flow of liquid through the chamber 1101 will be adapted accordingly with the liquid flowing into the channel 1103 through the top of the housing 1117 and out of a side of the housing 1117. In some examples, the mechanism 1107 may be positioned such that the function of the depicted entrance 1104 and the exit 1105 are reversed, such that liquid flows into the channel 1103 through the side of the housing 1117 and out of a top of the housing 1117. Channels of any shape may be similarly adapted. A cross-sectional shape of the entrance 1104 may be circular, oval, a figure-8 shape, square, rectangular, triangular and/or any other suitable cross-sectional shape.

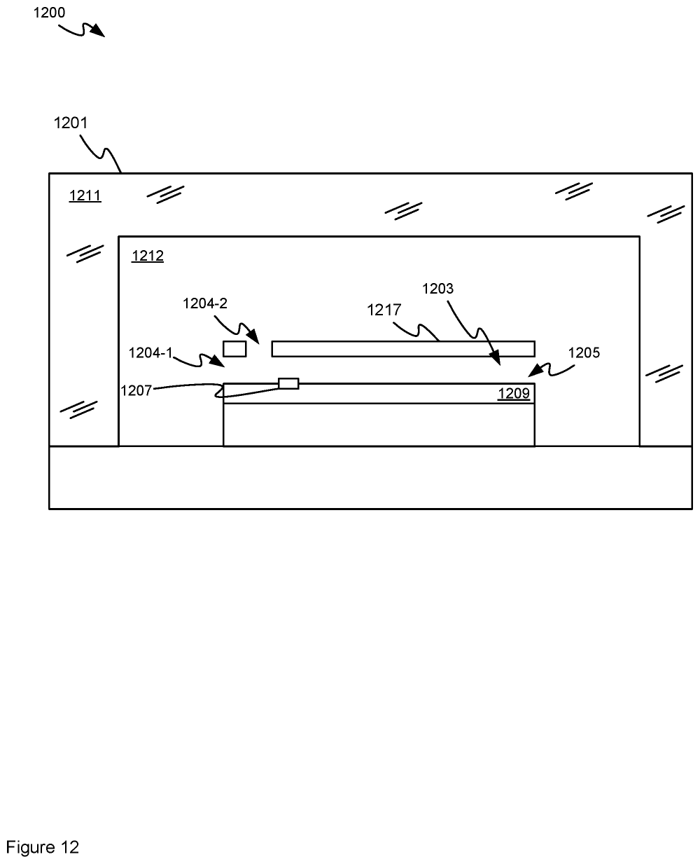

In some examples, the device 1100 may be adapted to include two entrances (or two exits). For example, attention is next directed to FIG. 12 which depicts a device 1200 similar to the device 1100, with like components having like numbers but in an “1200” series rather than an “1100” series. As depicted the device 1200 includes a chamber 1201 and a channel 1203 with two entrances 1204-1, 1204-1, an exit 1205, a mechanism 1207, and a controller 1209. The chamber 1201 generally comprises a lid 1211 and an interior space 1212. Hence, the device 1200 is similar to the device 100 but includes a first entrance 1204-1 to the channel 1203 at a side of a housing 1217 and a second entrance 1204-2 to the channel 1203 at a top of the housing 1217; the exit 1205 is on a side of the housing 1217 opposing the entrance 1204-1. Flow of liquid through the chamber 1201 will be adapted accordingly with the liquid flowing into the channel 1203 through the top and a side of the housing 1217 and out of an opposing side of the housing 1217. In some examples, the mechanism 1207 may be positioned such that the function of the depicted entrances 1204-1, 120402 and the exit 1205 are reversed, such that liquid flows into the channel 1203 through a side of the housing 1217 and out of an opposing side and a top of the housing 1217. Channels of any shape may be similarly adapted.

An entrance to a channel at a top of a housing of devices described herein may be of any suitable location and/or suitable size and/or suitable shape, for example relative to a respective mechanism. Similarly, a channel, for example in a region of a top entrance, may be of any suitable size and/or suitable shape.

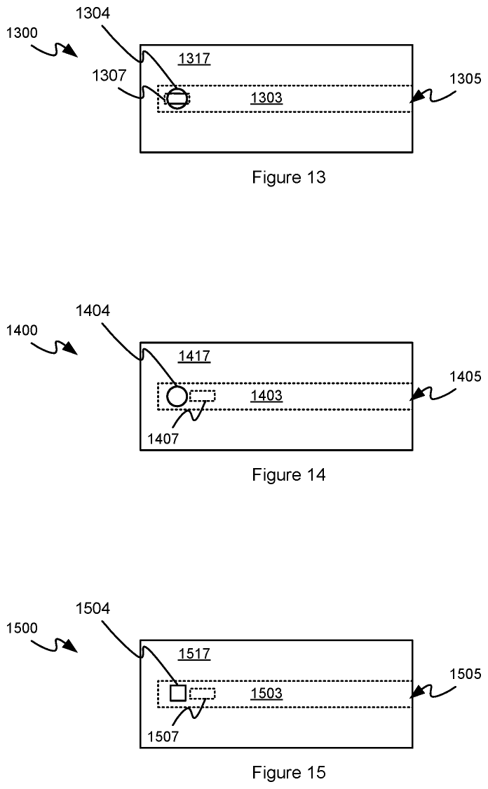

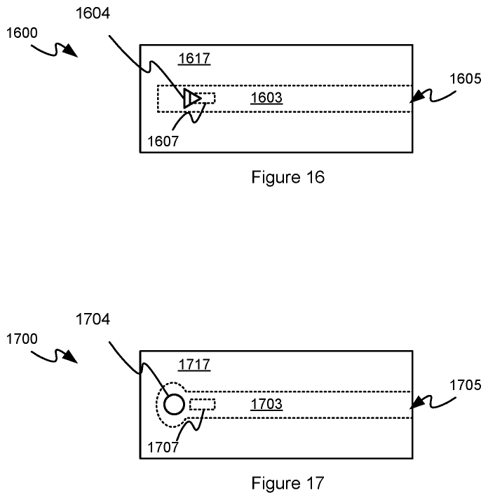

For example, attention is next directed to FIG. 13, FIG. 14, FIG. 15, FIG. 16 and FIG. 17 each of which depict top views of respective devices 1300, 1400, 1500, 1600 1700 (e.g. similar to FIG. 3 but without a chamber) comprising respective channels 1303, 1403, 1503, 1603 1703 having respective entrances 1304, 1404, 1504, 1604 1704 and exits 1305, 1405, 1505, 1605 1705, respective mechanisms 1307, 1407, 1507, 1607 1707, and the respective channels 1303, 1403, 1503, 1603 1703 being through respective housings 1317, 1417, 1517, 1617 1717. In each of the devices 1300, 1400, 1500, 1600 1700, the respective entrances 1304, 1404, 1504, 1604 1704 are in a top of a respective housing 1317, 1417, 1517, 1617 1717.

In the device 1300, the entrance 1304 to the channel 1303 is circular in cross-section, and located on and/or at the mechanism 1307, such that the entrance 1304 at least partially overlaps with the mechanism 1307. In contrast, in the device 1400, while the entrance 1404 to the channel 1403 is also circular, and the entrance 1404 located such that the entrance 1404 does not overlap with the mechanism 1407 and/or the entrance 1404 is located at an end of the channel 1403 opposite the exit 1405.

The device 1500 is similar to the device 1300, but the entrance 1504 is rectangular and/or square in cross-section. The device 1600 is similar to the device 1300, but the entrance 1604 is triangular in cross-section, with a tip of the triangular entrance 1604 at least partially overlapping with the mechanism 1609.

In the device 1700, the entrance 1704 to the channel 1703 is circular in cross-section, and an end of the channel 1703 opposite the exit 1705, over which the entrance 1704 is located, is oval and/or elliptical in shape as compared to the remainder of the channel 1703 which is narrower than the oval and/or elliptical end. Such a configuration may promote flow of fluid into the channel 1703.

Any of the devices described herein may be modified according to the entrances and channels described with respect to FIG. 13, FIG. 14, FIG. 15, FIG. 16 and FIG. 17. Furthermore, any suitable shapes of entrances and/or exits and/or channels are within the scope of the present specification. For example, a cross-sectional shape of the entrances and/or exits may be circular, oval, a figure-8 shape, square, rectangular, triangular and/or any other suitable cross-sectional shape.

Heretofore, devices have been described with respect to channels being fabricated on a pedestal extending from a substrate and extending into a chamber. However, in other examples, an entrance or an exit may be flush with a floor of a chamber.

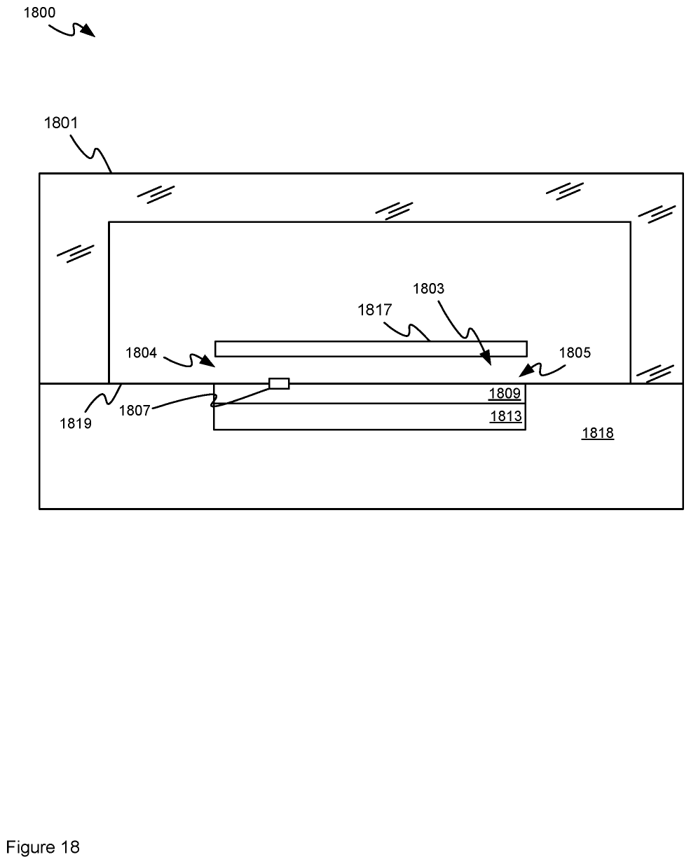

For example, attention is next directed to FIG. 18 which depicts a device 1800 similar to the device 200, with like components having like numbers, but in an “1800” series rather than a “200” series. As such, the device 1800 comprises: a chamber 201; a channel 1803 having an entrance 1804 within the chamber 1801 and an exit 1805 within the chamber 1801; a unidirectional displacement mechanism 1807 inside the channel 1803, the mechanism 1807 located between the entrance 1804 and the exit 1805; and a controller 1809 to activate the unidirectional displacement mechanism 1807 to cause fluid from the chamber 1801 to enter the microfluidic channel 1803 via the entrance 1804 and leave the microfluidic channel 1803 via the exit 1805 thereby agitating the fluid within the chamber 1801. As in the device 200, controller 1809 is fabricated on and/or located on a substrate 1813, and the channel 1803 is formed in a housing 1817. However, in contrast to the device 200, the controller 1809 and the substrate 1813 are placed in an overmold material 1818 such that the entrance 1804 and the exit 1805 are flush with a floor 1819 of the chamber 1801. The housing 1817 is above the floor 1819, as are the entrance 1804 and the exit 1805.

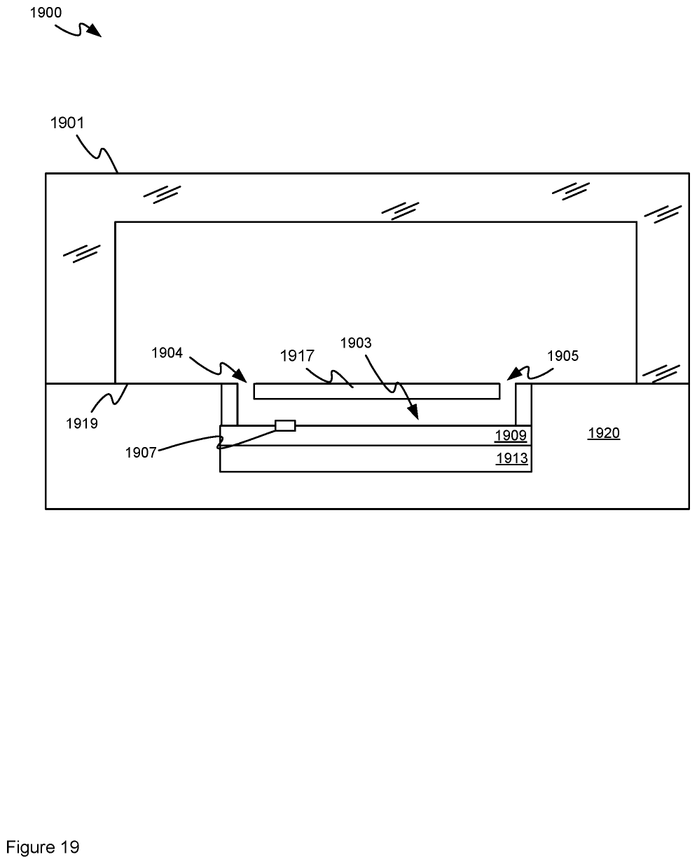

Similarly, attention is next directed to FIG. 19 which depicts a device 1900 similar to the device 1800, with like components having like numbers, but in a “1900” series rather than an “1800” series. As such, the device 1900 comprises: a chamber 201; a channel 1903 having an entrance 1904 within the chamber 1901 and an exit 1905 within the chamber 1901; a unidirectional displacement mechanism 1907 inside the channel 1903, the mechanism 1907 located between the entrance 1904 and the exit 1905; and a controller 1909 to activate the unidirectional displacement mechanism 1907 to cause fluid from the chamber 1901 to enter the microfluidic channel 1903 via the entrance 1904 and leave the microfluidic channel 1903 via the exit 1905 thereby agitating the fluid within the chamber 1901. As in the device 1800, controller 1909 is fabricated on and/or located on a substrate 1913, and the channel 1903 is formed in a housing 1917. However, in contrast to the device 1800, the controller 1909, the substrate 1913 and the housing 1917 are placed in an overmold material 1920, and the entrance 1904 and the exit 1905 are located in a top of the housing 1917 such that the entrance 1904 and the exit 1905 are flush with a floor 1919 of the chamber 1901.

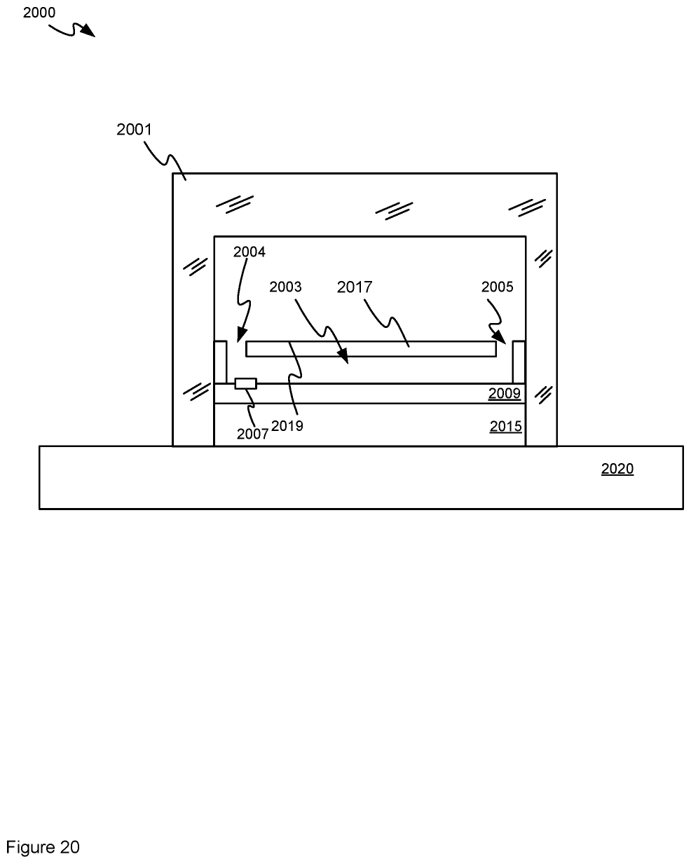

A similar arrangement may be obtained by adjusting interior walls of a chamber. For example, attention is next directed to FIG. 20 which depicts a device 2000 similar to the device 1900, with like components having like numbers, but in a “2000” series rather than a “1900” series. As such, the device 2000 comprises: a chamber 2001; a channel 2003 having an entrance 2004 within the chamber 2001 and an exit 2005 within the chamber 2001; a unidirectional displacement mechanism 2007 inside the channel 2003, the mechanism 2007 located between the entrance 2004 and the exit 2005; and a controller 2009 to activate the unidirectional displacement mechanism 2007 to cause fluid from the chamber 2001 to enter the microfluidic channel 2003 via the entrance 2004 and leave the microfluidic channel 2003 via the exit 2005 thereby agitating the fluid within the chamber 2001. As in the device 200, controller 2009 is fabricated on and/or located on a substrate 2015, the channel 2003 is formed in a housing 2017, and the entrance 2004 and the exit 2005 are located in a top of the housing 2017. However, in contrast to the device 1900, the substrate 2015 comprises a sliver substrate, interior side walls of the chamber 2001 are flush against side walls of the housing 2017, as well as the substrate 2015 such that a top of the housing 2017 forms a floor 2019 of the chamber 2001.

The configurations depicted in FIG. 18, FIG. 19 and FIG. 20 may be used with one or more of overmolded silicon chips, multi-sliver and/or multi-chip multiplexing microreactors (e.g. PCR, isothermal, and the like), and/or fluid molded interconnected devices (FMIDs). For example, the device 2000 may include an FMID substrate 2020. Indeed, any of the devices described herein, where suitable, maybe on FMID substrates.

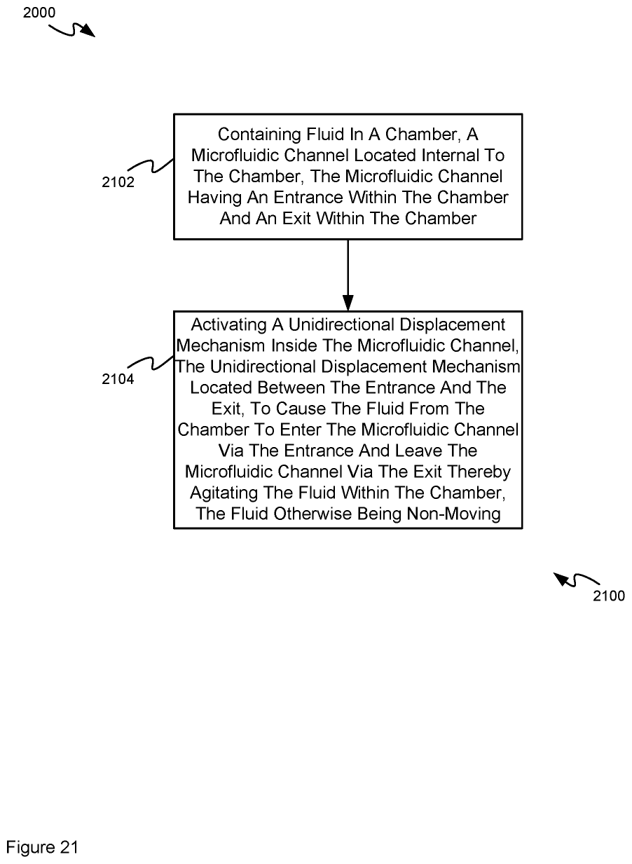

Attention is next directed to FIG. 21 which depicts is a flow chart of a method 2100 for use with a device with a microfluidic channel for use in a chamber, according to an example of the principles described herein. The method 2100 may be implemented using any of the devices described herein. A block 2102 of the method 2100, comprises containing fluid in a chamber, a microfluidic channel located internal to the chamber, the microfluidic channel having an entrance within the chamber and an exit within the chamber. For example, the fluid may be introduced into the chamber using any suitable fluid manipulation device, such as a pipette, and the like, which may be operated via an automatic positioning device and/or manually. A block 2104 of the method 2100 comprises activating a unidirectional displacement mechanism inside the microfluidic channel, the unidirectional displacement mechanism located between the entrance and the exit, to cause the fluid from the chamber to enter the microfluidic channel via the entrance and leave the microfluidic channel via the exit thereby agitating the fluid within the chamber, the fluid otherwise being non-moving. Agitation of the fluid in the chamber hence occurs via the block 2104 which may cause chemicals, and the like, in the fluid to react; for example, a PCR may occur and/or be accelerated due to such agitation.

It should be recognized that features and aspects of the various examples provided above may be combined into further examples that also fall within the scope of the present disclosure.

1. A device comprising:
a chamber to contain a fluid;
a microfluidic channel located internal to the chamber, the microfluidic channel having an entrance within the chamber and an exit within the chamber, the microfluidic channel defined by a housing located within the chamber;
a unidirectional displacement mechanism inside the microfluidic channel, the unidirectional displacement mechanism located between the entrance and the exit; and
a controller to activate the unidirectional displacement mechanism to cause the fluid from the chamber to enter the microfluidic channel via the entrance and leave the microfluidic channel via the exit thereby agitating the fluid within the chamber, the fluid otherwise being non-moving.

2. The device of claim 1, wherein the housing has a top hat configuration extending into the chamber.

3. The device of claim 1, wherein the controller comprises a complementary metal-oxide-semiconductor (CMOS) controller.

4. The device of claim 1, wherein the entrance and the exit of the microfluidic channel are located on opposing sides of the housing.

5. The device of claim 1, wherein one of the entrance and the exit of the microfluidic channel is located on a top side of the housing and the other of the entrance and the exit of the microfluidic channel is located on a side of the housing perpendicular to the top side.

6. The device of claim 1, wherein the unidirectional displacement mechanism comprises a thermal inkjet resistor.

7. The device of claim 1, further comprising:
a second microfluidic channel having a second entrance within the chamber and a second exit within the chamber;
a second unidirectional displacement mechanism inside the second microfluidic channel, the second unidirectional displacement mechanism located between the second entrance and the second exit; and
the controller to activate the second unidirectional displacement mechanism to cause the fluid from the chamber to enter the second microfluidic channel via the second entrance and leave the microfluidic channel via the second exit.

8. A method comprising:
containing fluid in a chamber, wherein a microfluidic channel is located internal to the chamber, the microfluidic channel having an entrance within the chamber and an exit within the chamber;
activating a unidirectional displacement mechanism inside the microfluidic channel, the unidirectional displacement mechanism located between the entrance and the exit, to cause the fluid from the chamber to enter the microfluidic channel via the entrance and leave the microfluidic channel via the exit thereby agitating the fluid within the chamber, the fluid otherwise being non-moving.

9. The method of claim 8, further comprising activating the unidirectional displacement mechanism to cause the fluid from the chamber to enter the microfluidic channel via the entrance and leave the microfluidic channel via the exit and a second exit.

10. The method of claim 8, wherein a second microfluidic channel is located internal to the chamber, the second microfluidic channel having a second entrance within the chamber and a second exit within the chamber, and wherein the method further comprises:
activating a second unidirectional displacement mechanism inside the second microfluidic channel, the second unidirectional displacement mechanism located between the second entrance and the second exit, to cause the fluid from the chamber to enter the second microfluidic channel via the second entrance and leave the microfluidic channel via the second exit.

11. The method of claim 8, further comprising providing the entrance and the exit are above a floor of the chamber.

12. The method of claim 8, further comprising providing the entrance and the exit flush with a floor of the chamber.

13. The method of claim 8, wherein the unidirectional displacement mechanism comprises a thermal inkjet resistor inkjet device, and activating unidirectional displacement mechanism comprises activating the thermal inkjet resistor inkjet device.

14. The method of claim 8, further comprising providing the microfluidic channel as straight, U-shaped or a combination thereof.

15. A device comprising:
a chamber to contain a fluid;
a microfluidic channel located internal to the chamber, the microfluidic channel having an entrance within the chamber and an exit within the chamber, the microfluidic channel defined by a housing located within the chamber, the microfluidic channel being straight;
a thermal inkjet resistor inside the microfluidic channel, the thermal inkjet resistor located between the entrance and the exit; and
a controller to activate the thermal inkjet resistor to cause the fluid from the chamber to enter the microfluidic channel via the entrance and leave the microfluidic channel via the exit thereby agitating the fluid within the chamber, the fluid otherwise being non-moving.
